(19) United States
(12) Patent Application Publication
(10) Pub. No.: US 2011/0123802 A1
(43) Pub. Date: May 26, 2011

(54) POLYOLEFIN COMPOSITIONS SUITABLE FOR ELASTIC ARTICLES

(75) Inventors: Andy C. Chang, Houston, TX (US); Monica A. Trahan, Clute, TX (US); Rajen M. Patel, Lake Jackson, TX (US)

(73) Assignee: Dow Global Technologies LLC, Midland, MI (US)

(21) Appl. No.: 13/054,599

(22) PCT Filed: Jul. 15, 2009
(86) PCT No.: PCT/US2009/050643

§ 371 Date: Jan. 18, 2011

Related U.S. Application Data
(60) Provisional application No. 61/081,979, filed on Jul. 18, 2008.

(51) Int. Cl. B32B 27/08; C08F 110/02; C08F 110/06; C08F 293/00; B32B 27/02

(52) U.S. Cl. 428/394; 526/352; 526/351; 428/516; 525/323

(57) ABSTRACT

The present invention describes an elastic article comprising at least one low crystallinity polymer layer and optionally a high crystallinity polymer layer. The low crystallinity polymer layer comprises a low crystallinity polymer and optionally an additional polymer. The optional high crystallinity polymer layer comprises a high crystallinity polymer having a melting point within about 50° C. of the melting point of the low crystallinity polymer. The article is elongated at a temperature below the melting point of the low crystallinity polymer and the optional high crystallinity polymer in at least one direction to an elongation of at least about 50% of its original length or width. Subsequently, the article may be heat-shrunk at a temperature not greater than 10° C. above the melting point of the low crystallinity polymer.

### FIELD OF THE INVENTION

This invention pertains to elastic articles comprising single or multi-layered articles such as film articles, non-woven fabric articles, and fibrous articles. In one aspect, the invention pertains to elastic articles comprising low density polyolefin elastomers. In another aspect, the invention pertains to heat shrunk elastic articles.

### BACKGROUND OF THE INVENTION

Many health care products, protective wear garments, and personal care products in use today are available as disposable products. Disposable products are products that are used up to a few times before being discarded. Disposable products, especially consumer-related products, often have one or more elastic element that are integral to their use, function, or appeal. Elastic polymers are generally high molecular weight amorphous polymers that would appear well-suited to disposable product service. It is known, however, that elastic polymers may be difficult to process into articles such as films and fibers which are used for elements of some disposable products.

### SUMMARY OF THE INVENTION

In an embodiment, the invention relates to an article comprising a low crystallinity polymer layer comprised of a low crystallinity polymer. The article has an original length and original width. The article is elongated at a temperature below the melting point of the low crystallinity polymer to an elongation of at least 50% in at least one direction of the article's original length or original width. In doing so, the article is formed into a pre-stretched article with an initial permanent set.

In an embodiment, the invention relates to an article comprising a low crystallinity polymer layer comprised of a low crystallinity polymer and a high crystallinity polymer layer comprised of a high crystallinity polymer. The high crystallinity polymer has a melting point, as determined by Differential Scanning Calorimetry (DSC), within about 25° C. of the melting point of the low crystallinity polymer. The article has an original length and original width. The article is elongated at a temperature below the melting point of the low crystallinity polymer to an elongation of at least 50% in at least one direction of the article's original length or original width. In doing so, the article is formed into a pre-stretched article with an initial permanent set

In another embodiment, the invention relates to a process where an article comprising a low crystallinity polymer layer, and optionally a high crystallinity polymer layer, is made, then elongated, and then heat shrunk. The article has an original length and an original width. The article is elongated at a temperature below the melting point of the low crystallinity polymer to an elongation of at least 50% in at least one direction of the article's original length or original width. In doing so, the article is formed into a pre-stretched article with an initial permanent set. The pre-stretched article is then heat-shrunk at a temperature not greater than 10° C. above the melting point of the low crystallinity polymer, forming a heat-shrunk article with a post-shrink permanent set. The post-shrink permanent set is reduced by at least 25% as compared to the initial permanent set.

In another embodiment, the invention relates to a process where an article comprising a low crystallinity polymer layer, and optionally a high crystallinity polymer layer, is made, then elongated, and then heat shrunk. The article has an original length and an original width. The article is elongated at a temperature below the melting point of the low crystallinity polymer to an elongation of at least 50% in at least one direction of the article's original length or original width. In doing so, the article is formed into a pre-stretched article with an initial permanent set.

### BRIEF DESCRIPTION OF THE DRAWINGS

FIG. 1 is a plot depicting the effect of heat on permanent set on several test films of an example polymer (Example C1-c, C2, C3, C4 after a pre-strain of 300%).

FIG. 2 is a plot depicting the effect of heat on permanent set on several test films of an example polymer (Example A1-c, A2, A3, A4, A5, and A6 after a pre-strain of 900%).

FIG. 3 is a plot depicting the effect of heat on permanent set on several test films of an example polymer (Example D1, D2, D3, D4, D5, and D6 after a pre-strain of 900%).

FIG. 4 is a plot depicting the effect of heat on permanent set on several test films of an example polymer (Example E1-c, E2, E3, E4, E5, and E6 after a pre-strain of 900%).

FIG. 5 is a plot depicting the effect of heat on permanent set on several test films of an example polymer (Example F1-c, F2, F3, F4, F5, F6, and F7 after a pre-strain of 900%).

### DETAILED DESCRIPTION OF THE INVENTION

“Polymer” means a substance composed of molecules with large molecular mass consisting of repeating structural units, or monomers, connected by covalent chemical bonds. The term “polymer” generally includes, but is not limited to, homopolymers, copolymers such as block, graft, random and alternating copolymers, terpolymers, etc., and blends and modifications thereof. Further, unless otherwise specifically limited, the term “polymer” includes all possible geometrical configurations of the molecular structure. These configurations include, but are not limited to, isotactic, syndiotactic, and random configurations.

“Interpolymer” means a polymer prepared by the polymerization of at least two different types of monomers. The term “interpolymer” includes the term “copolymer” (which is usually employed to refer to a polymer prepared from two different monomers) as well as the term “terpolymer” (which is usually employed to refer to a polymer prepared from three different types of monomers). It also encompasses polymers made by polymerizing four or more types of monomers.

The term “ethylene/α-olefin interpolymer” generally refers to polymers comprising ethylene and an α-olefin having 3 or more carbon atoms. Preferably, ethylene comprises the majority mole fraction of the whole polymer, i.e., ethylene comprises at least about 50 mole percent of the whole polymer. The substantial remainder of the whole polymer comprises at least one other comonomer that is preferably an α-olefin having 3 or more carbon atoms. For an ethylene/octene copolymer, in some embodiments, the composition may comprise an ethylene content greater than about 80 mole percent of the whole polymer and an octene content of from about 10 to about 20 mole percent of the whole polymer. In some embodiments, the ethylene/α-olefin interpolymers do not include polymers produced in low yields, in minor amounts, or as by-products. While the ethylene/α-olefin interpolymers may be blended with one or more polymers, the as-produced ethylene/α-olefin interpolymers are substantially pure and often comprise a major component of the reaction product of a polymerization process.

The term “multi-block copolymer” or “segmented copolymer” refers to a polymer comprising two or more chemically distinct regions or segments (“blocks”) preferably joined in a linear manner, i.e., a polymer comprising chemically differentiated units which are joined end-to-end with respect to polymerized ethylenic functionality, rather than in pendent or grafted fashion. In a some embodiments, the blocks differ in the amount or type of comonomer incorporated, the density, the amount of crystallinity, the crystallite size attributable to the polymer of such composition, the type or degree of tacticity (isotactic or syndiotactic), regio-regularity or regio-irregularity, the amount of branching, including long chain branching or hyper-branching, the homogeneity, or any other chemical or physical property. The multi-block copolymers are characterized by unique distributions of polydispersity index (PDI or M_{w}/Mₙ), block length distribution, or block number distribution due to the process of making of the copolymers. When produced in a continuous process, in some embodiments the polymers possess PDI from about 1.7 to 2.9. In some embodiments, the polymers possess PDI from about 1.8 to 2.5. In some embodiments, the polymers possess PDI from about 1.8 to 2.2. In some embodiments, the polymers possess PDI from about 1.8 to 2.1. When produced in a batch or semi-batch process, in some embodiments the polymers possess PDI from about 1.0 to 2.9. In some embodiments, the polymers possess PDI from about 1.3 to 2.5. In some embodiments, the polymers possess PDI from about 1.4 to 2.0. In some embodiments, the polymers possess PDI from about 1.4 to 1.8.

“Crystallinity” means atomic dimension or structural order of a polymer composition. Crystallinity is often represented by a fraction or percentage of the volume of the material that is crystalline or as a measure of how likely atoms or molecules are to be arranged in a regular pattern, namely into a crystal. Crystallinity of polymers can be adjusted fairly precisely and over a very wide range by heat treatment. A “crystalline” “semi-crystalline” polymer possesses a first order transition or crystalline melting point (Tₘ) as determined by DSC or equivalent technique. The term may be used interchangeably with the term “semicrystalline”. The term “amorphous” refers to a polymer lacking a crystalline melting point as determined by DSC or equivalent technique.

The term “extensible” means elongatable in at least one direction, but not necessarily recoverable. In some embodiments, the term refers to the ability to be stretched at least 50% without breaking. In some embodiments, the term refers to the ability to be stretched at least 100% without breaking. In some embodiments, the term refers to the ability to be stretched at least 125% without breaking. In some embodiments, the term refers to the ability to be stretched at least 175%.

“Elastomeric” means that the material will substantially resume its original shape after being elongated. To qualify a material as elastomeric and be suitable for the first component, a 1-cycle hysteresis test to 80% strain is used. For this test, the specimens (6 inches long by 1 inch wide) (152.40 mm by 25.40 mm) are loaded lengthwise into a Sintech type mechanical testing device fitted with pneumatically-activated line-contact grips with an initial separation of 4 inches. The sample is stretched to 80% strain at 500 mm/minute, and returned to 0% strain at the same speed. The strain at 10 g load upon retraction is taken as the set. Upon immediate and subsequent extension, the onset of positive tensile force is taken as the set strain. The hysteresis loss is defined as the energy difference between the extension and retraction cycle. The load down is the retractive force at 50% strain. In all cases, the samples are measured “green” or unaged. Strain is defined as the percent change in sample length divided by the original sample length (22.25 mm) equal to the original grip separation. Stress is defined as the force divided by the initial cross sectional area.

As previously mentioned, the terms “low crystallinity” and “high crystallinity” are relative and not absolute. Example high crystallinity polymers include linear low density polyethylene (LLDPE), low density polyethylene (LDPE), high density polyethylene (HDPE), homopolypropylene (hPP), and random copolymer of propylene (RCP). Examples of low crystallinity copolymers include, but are not limited to, copolymers of propylene-ethylene, propylene-1-butene, propylene-1-octene, styrene-ethylene-butylene-styrene (SEBS), styrene-butadiene-styrene (SBS), and styrene-isoprene-styrene (SIS).

The term “thermoplastic” refers to a polymer which is capable of being melt processed.

The term “high pressure low density type resin” is defined to mean that the polymer is partially or entirely homopolymerized or copolymerized in autoclave or tubular reactors at pressures above 14,500 psi (100 MPa) with the use of free-radical initiators, such as peroxides (e.g., U.S. Pat. No. 4,599,392 (McKinney, et al.)). “LDPE” is an example of this type of resin and may also be referred to as “high pressure ethylene polymer” or “highly branched polyethylene”. The cumulative detector fraction (CDF), as defined in PCT Published Application No. WO 2006/073962 (Butler, et al.), of these materials is greater than about 0.02 for molecular weight greater than 1000000 g/mol as measured using light scattering. CDF may be determined as described in PCT Published Application No. WO 2005/023912 (Oswald, et al.).

“High pressure low density type resin” also includes branched polypropylene materials (both homopolymer and copolymer). “Branched polypropylene materials” means the type of branched polypropylene materials disclosed in PCT Published Application No. WO 2003/082971 (Sehanobihs, et al.).

The term “machine direction” (MD) means the length of a fabric, film, fiber, or laminate in the direction in which it is produced. The terms “cross machine direction” or “cross directional” (CD) mean the width of fabric, film, fiber, or laminate, i.e., a direction generally perpendicular to the MD.

The term “layer” means a relatively uniform thickness of a predominantly homogeneous substance. A layer can be discontinuous, where the area(s) of discontinuation lack the predominantly homogeneous substance partially or completely but are spatially defined as being within the layer by the presence of the predominantly homogeneous substance bordering or surrounding the area(s) of discontinuation. A layer is defined as being comprised of at least 50% and up to 100% of the predominantly homogeneous substance.

The term “nonwoven layer” means a polymeric layer having a structure of individual fibers or threads which are interlaid, but not in an identifiable, repeating manner. Nonwoven layers are formed by a variety of processes, for example, meltblowing processes, spunbonding processes, hydroentangling, air-laid, and bonded carded web processes.

The term “bonded carded webs” refers to webs that are made from staple fibers which are usually purchased in bales. The bales are placed in a fiberizing unit or picker, which opens the bale from the compact state and separates the fibers. Next, the fibers are sent through a combining or carding unit, which further breaks apart and aligns the staple fibers in the machine direction, so as to form a machine direction-oriented fibrous non-woven web. Once the web has been formed, it is bonded by one or more of several bonding methods. One bonding method is powder bonding, where a powdered adhesive is distributed throughout the web and then activated, usually by heating the web and adhesive with hot air. Another bonding method is pattern bonding, where heated calendar rolls or ultrasonic bonding equipment is used to bond the fibers together, usually in a localized bond pattern through the web. Alternatively, the web may be bonded across its entire surface. When using bicomponent staple fibers, through-air bonding equipment is often used.

The term “spunbond” refers to small diameter fibers which are formed by extruding molten thermoplastic material as filaments from a plurality of fine, usually circular, capillaries of a spinneret with the diameter of the extruded filaments being rapidly reduced as by for example in U.S. Pat. Nos. 4,340,563 (Appe); 3,692,618 (Dorschner, et al.); 3,802,817 (Matsuki, et al.); 3,338,992 (Kinney); 3,341,394 (Kinney); and 3,542,615 (Dobo, et al).

The term “meltblown” means fibers formed by extruding a molten thermoplastic material through a plurality of fine, usually circular, die capillaries as molten threads or filaments into converging high velocity gas (e.g., air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltdown fibers. Such a process is disclosed, in various patents and publications, including NRL Report 4364, “Manufacture of Super-Fine Organic Fibers” by B. A. Wendt, E. L. Boone and D. D. Fluharty; NRL Report 5265, “An Improved Device For The Formation of Super-Fine Thermoplastic Fibers” by K. D. Lawrence, R. T. Lukas, J. A. Young; and U.S. Pat. No. 3,849,241 (Butin, et al).

The terms “sheet” or “sheet material” refer to woven materials, nonwoven webs, polymeric films, polymeric scrim-like materials, and polymeric foam sheeting.

The basis weight of nonwoven fabrics is usually expressed in ounces of material per square yard (osy) or grams per square meter (g/m2 or gsm). The fiber diameters are usually expressed in microns. Film thicknesses may be expressed in microns.

The term “elastomeric” is interchangeable with the term “elastic”. Both terms refer to sheet material which, upon application of a stretching force, is stretchable in at least one direction (e.g., the CD direction), and which upon release of the stretching force contracts or returns to approximately its original dimension. For example, a stretched material having a stretched length which is at least 50 percent greater than its relaxed unstretched length, and which will recover to within at least 50 percent of its stretched length upon release of the stretching force. A hypothetical example of an elastomeric material in this condition would be a 1 inch (25.4 mm) sample of a material, which is stretchable to at least 1.50 inches (38.1 mm) and upon release of the stretching force will recover to a length of not more than 1.25 inches (31.75 mm). The term “inelastic” or “nonelastic” refers to any material which does not fall within the definition of “elastic”.

In some embodiments, an elastomeric sheet contracts or recovers up to 50 percent of the stretch length in the cross machine direction using a cycle test to determine percent set. In some embodiments, an elastomeric sheet material recovers up to 80 percent of the stretch length in the cross machine direction using a cycle test. In some embodiments, an elastomeric sheet material recovers greater than percent of the stretch length in the cross direction using a cycle test.

In some embodiments, an elastomeric sheet is stretchable and recoverable in both the MD and CD directions. For this application, values of load loss and other “elastomeric functionality testing” have been measured in the CD direction, unless otherwise noted. Such test values have been measured at 50 percent elongation on a 70 percent total elongation cycle (as described further in the Test Method section).

The term “strain” is measured as a percentage change in dimension of a sample. Specifically, it is defined as the percent change in sample length in the original distance between tabs of the ASTM D1708 microtensile specimen per Equation 1:

$$Strain ( \% ) = \frac{{L}_{i} - {L}_{o}}{{L}_{o}} \times 100 \% , \qquad ( Eq . 1 )$$

where Lₒ is the original distance between tabs (22.25 mm) and Lᵢ is the length of the specimen after a given treatment. For the ASTM D1708 geometry, Lₒ is taken to be 22.25 mm. Lᵢ is measured during deformation in an INSTRON 5564 using crosshead displacement. For heat shrinkage specimens, Lᵢ is the length of the test section between the tabs measured using calipers. Multiple specimens are typically tested and measured for a given testing condition in order that an average “set(%)” and its corresponding standard deviation may be calculated.

The terms “permanent set”, “set strain”, and “set” refer to a strain in a material sample under no load following a specific treatment. Such a treatment can be mechanical deformation such as elongation during pre-stretching or heat shrinkage by exposure to elevated temperatures, or combinations thereof.

The terms “Initial Permanent Set (%)” and “Post-Shrink Permanent Set (%)” are used to describe certain properties. These terms refer to measures of set(%) after specific treatments. Initial Permanent Set (%) refers to the strain measured after an initial pre-stretching step. Post-Shrink Permanent Set (%) refers to the strain after a sample has undergone heat shrinkage.

“Stress” is defined as the force divided by the cross sectional area of the narrow portion of the ASTM D1708 microtensile specimen prior to deformation. This is calculated by multiplying the width taken to be 4.8 mm by the thickness which is measured using calipers prior to deformation. Stress is typically quantified in units of force per area such as Pascals (Pa) our pounds per square inch (psi).

The term “laminate” refers to a composite structure of two or more sheet material layers that have been adhered through at least one bonding step, such as through-air bonding, adhesive bonding, thermal bonding, point bonding, pressure bonding, extrusion coating or ultrasonic bonding.

The term “through-air bonding” refers to the family of processes which operate based on the principle of forcing air that is typically heated through the bulk of a layer or a multitude of layers. The heat transferred to the structure results in the development of adhesion of components such as layers or constituents which comprise a layer. This can be achieved by melting of one or more components present in one or more layers. For example, a “binder fiber” comprising a lower melting sheath and a higher melting core can melt and bond together other components of a given layer. Sometimes, these binder fibers are dispersed within other fibers and serve to adhere other fibers of the structure together.

In another example, a film which is heated by through-air bonding can melt to an adjoining film or nonwoven layer.

The term “thermal bonding” involves passing a fabric or web of fibers to be bonded between a heated calendar roll and an anvil roll. The calendar roll is usually, though not always, patterned in some way so that the fabric is not bonded across its entire surface. The anvil roll is usually flat.

The term “ultrasonic bonding” means a process performed, for example, by passing the fabric between a sonic horn and anvil roll as illustrated in U.S. Pat. No. 4,374,888 (Bornslaeger).

The term “adhesive bonding” means a bonding process which forms a bond by application of an adhesive. Such application of adhesive may be by various processes such as slot coating, spray coating and other topical applications. Further, such adhesive may be applied within a product component and then exposed to pressure such that contact of a second product component with the adhesive containing product component forms an adhesive bond between the two components.

The term “personal care product” means diapers, training pants, swimwear, absorbent underpants, adult incontinence products, and feminine hygiene products, such as feminine care pads, napkins and pantiliners.

The term “protective outer wear” means garments used for protection in the workplace, such as surgical gowns, hospital gowns, masks, and protective coveralls.

The term “protective cover” means covers that are used to protect objects such as for example car, boat and barbeque grill covers, as well as agricultural fabrics.

“Additive” includes particulates or other forms of materials which can be added to a polymer extrusion material which will not chemically interfere with or adversely affect the extruded article and further which are capable of being dispersed throughout the article.

The terms “cured” and “substantially cured” mean the elastic polymer or elastic polymer composition or the shaped article comprised of the elastic polymer or elastic polymer composition is subjected or exposed to a treatment which induced crosslinking.

The term “cross-linked” means an elastic polymer, an elastic polymer composition, or a shaped article comprised of the elastic polymer or elastic polymer composition characterized as having xylene extractables of less than or equal to 45 wt % (i.e., greater than or equal to 55 wt % gel content), where xylene extractables (and gel content) are determined in accordance with ASTM D-2765. In some embodiments, xylene extractables are less than or equal to 40 wt % (i.e., greater than or equal to 60 wt % gel content). In some embodiments, xylene extractables are less than or equal to 35 wt % (that is, greater than or equal to 65 wt % gel content).

The combination of “low crystallinity” and “high crystallinity” materials in a variety of ways enables advantaged elastic properties previously only offered in more limited forms. These materials comprise “low crystallinity” and “high crystallinity” layers which in turn comprise the article. The heat-shrinking step of the embodiments may take less than one minute. The pre-stretching step may be performed on the entire laminate structure rather than the individual elastomer layers. The pre-stretching of the laminated structure is not restricted to one direction—it is capable of being performed in more than one direction. The article is the multilayer structure which can be used to fabricate an end-use product.

### Low Crystallinity Polymer

In one embodiment, the low crystallinity polymer comprises at least one of a homopolymer of ethylene, a copolymer of ethylene, and one or more comonomers selected from C₃-C₂₀ α-olefins. In some embodiments, the low crystallinity polymer has a heat of fusion in the range of about 3 to about 50 J/g and a molecular weight distribution in the range of about 1.7 to about 4.5 J/g. In some embodiments, the low crystallinity polymer has a density in the range of about 0.86 to about 0.89 g/cm³ and a MI in the range of about 0.1 to about 10000 g/10 minutes. In some embodiments, the MI is in the range of about 0.1 to about 1000 g/10 minutes.

In some embodiments, the ethylene copolymer has a comonomer content of greater than 10 mol %. Preferably, the ethylene copolymer is selected from the group consisting of ethylene/octene, ethylene/hexene, ethylene/butene, and ethylene/propylene with a density in the range of about 0.86 to about 0.88 g/cm³ and MI in the range of about 0.1 to about 30 g/10 minutes. More preferably, the copolymers are selected from the group consisting of ethylene/octene, ethylene/hexene, and ethylene/butene with a density in the range of about 0.86 to about 0.88 g/cm³ and MI in the range of about 0.1 to about 20 g/10 minutes.

In another embodiment, the low crystallinity polymer comprises at least one of a homopolymer of propylene, and a copolymer of propylene and one or more comonomers selected from ethylene and C₄-C₂₀ α-olefins. In some embodiments, the propylene homopolymer or copolymer has a comonomer content of about 17 mol %. In some embodiments, the MFR is in the range of about 0.1 to about 1000 g/10 minutes. In some embodiments, the comonomer present in the propylene copolymer is ethylene. In some embodiments, the propylene copolymer comprises about 3 to about 16.5 wt % ethylene comonomer and has an MFR in the range of about 1 to about 25 g/10 minutes. In some embodiments, the propylene copolymer comprises about 9 to about 16.5 wt % ethylene comonomer and has an MFR in the range of about 1 to about 25 g/10 minutes.

Homopolymer polypropylenes typically have a MFR in the range of about 0.1-1000 g/10 minutes. Density is about 0.9 g/cm³ (ASTM D792).

The comonomer content of the low crystallinity polymer is in the range of about 2 to about 25 wt % of the total weight of the low crystallinity polymer.

In an embodiment, the low crystallinity polymer has a degree of crystallinity of up to about 20 wt % after about 48 hours at ambient conditions (20° C., 50% relative humidity) after manufacture.

The low crystallinity polymer can be produced by any process that provides the desired polymer properties.

In one embodiment, the low crystallinity polymer comprises thermoplastic elastomers. Examples of thermoplastic elastomers include, but are not limited to, styrene block copolymers (SBC), ethylene based polymers, propylene based polymers, and blends thereof.

Examples of ethylene copolymers with elastic properties include, but are not limited to, AFFINITY™ PL 1880G polyolefin plastomer and ENGAGE™ 8100 polyolefin elastomer from The Dow Chemical Company (Midland, Mi) and EXACT™ from Exxon-Mobil Corporation (Irving, Tx). Examples of propylene copolymers with elastic properties include, but are not limited to, VERSIFY™2300 elastomer from Dow and VISTAMAXX™ from Exxon-Mobil.

In another embodiment, the low crystallinity polymer comprises an olefin block copolymer (OBC). These olefinic block copolymers, comprise ethylene and one or more copolymerizable □-olefin comonomers in polymerized form, characterized by multiple blocks or segments of two or more polymerized monomer units differing in chemical or physical properties. That is, the ethylene/α-olefin interpolymers are block interpolymers, or OBCs. In some embodiments, interpolymers are multi-block interpolymers or copolymers. The terms “interpolymer” and copolymer” are used interchangeably. In some embodiments, the multi-block copolymer can be represented by Formula 1:

(AB)ₙ (Formula 1),

where “n” is at least 1, preferably an integer greater than 1, “A” represents a hard block or segment and ‘B’ represents a soft block or segment. Preferably, A's and B's are linked in a substantially linear fashion, as opposed to a substantially branched or substantially star-shaped fashion. In other embodiments, A blocks and B blocks are randomly distributed along the polymer chain. In other words, the block copolymers usually do not have a structure as represented in Formula 2:

AAA-AA-BBB-BB (Formula 2).

Olefin block copolymers include those described in PCT Published Application Nos. WO 2005/090425, WO 2005/090427, and WO 2005/090426 (Arriola, et al.).

Examples of styrenic block copolymers are described, in but is not limited to, European Patent No. 0712892 B1 (Djiauw, et al.); PCT Published Application No. WO 2004/041538 (Morman, et al.); U.S. Pat. No. 6,582,829 (Quinn, et al.); U.S. Patent Publication Nos. 2004/0087235 (Morman, et al.), 2004/0122408 (Potnis, et al.), 2004/0122409 (Thomas, et al.); U.S. Pat. Nos. 4,789,699 (Kieffer, et al.), 5,093,422 (Himes), 5,332,613 (Taylor, et al.), and 6,916,750 B2 (Thomas et al.); U.S. Patent Publication No. 2002/0052585 (Thomas, et al.); and U.S. Pat. Nos. 6,323,389 (Thomas, et al.) and 5,169,706 (Collier, I V, et al.).

Styrenic block copolymers (SBC) that may be suitable for use in the invention include but are not limited to polymers such as styrene-ethylene-propylene-styrene (SEPS), styrene-ethylene-propylene-styrene-ethylene-propylene (SEPSEP), hydrogenated polybutadiene polymers such as styrene-ethylene-butylene-styrene (SEBS), styrene-ethylene-butylene-styrene-ethylene-butylene (SEBSEB), styrene-butadiene-styrene (SBS), styrene-isoprene-styrene (SIS), styrene-ethylene-styrene (SES), and hydrogenated poly isoprene/butadiene polymer such as styrene-ethylene-ethylene propylene-styrene (SEEPS).

In general, styrenic block copolymers suitable for the embodiments have at least two monoalkenyl arene blocks, preferably two polystyrene blocks, separated by a block of saturated conjugated diene comprising less than 20% residual ethylenic unsaturation, preferably a saturated polybutadiene block. In some embodiments, the two monoalkenyl arene blocks are two polystyrene blocks. In some embodiments, the block of saturated conjugated diene is a saturated polybutadiene block. In some embodiments, styrenic block copolymers have a linear structure although branched or radial polymers or functionalized block copolymers make useful compounds.

In an embodiment, the styrenic block copolymers comprise the majority polymer component of at least one layer of the structure. In another embodiment, the majority polymer component of at least one layer of the structure comprises a blend comprising ethylene/alpha-olefin with at least one styrenic block copolymer as described in U.S. Statutory Invention Registration H1808 (Djiauw, et al), European Patent No. 0712892 B1; German Patent No. 69525900-8; Spanish Patent No. 2172552; and PCT Published Application No. WO 2002/028965 (Djiauw, et al). In another embodiment, the majority polymer component of at least one layer of the structure comprises a blend of an ethylene/α-olefin multi-block interpolymer with at least one styrenic block copolymer as described in U.S. Patent Publication No. 2007/0078222 (Chang, et al.). In another embodiment, the majority polymer component of at least one layer of the structure comprises a blend comprising propylene/α-olefin copolymer with at least one styrenic block copolymer as described in PCT Published Application No. WO 2007/094866 (Chang).

In another embodiment of the invention, at least one SBC-based composition is used from the group of materials described in at least one of the publications: PCT Published Application No. WO 2007/027990 A2 (Flood, et al.); U.S. Pat. No. 7,105,559 (South, et al.); European Patent No. 1625178 B1 (Uzee, et al.); U.S. Patent Publication Nos. 2007/0055015 A1 (Flood, et al.) and 2005/0196612 A1 (Flood, et al.); PCT Published Application No. WO 2005/092979 A1 (Flood, et al.); U.S. Patent Publication Nos. 2007/0004830 A1 (Flood, et al.) and 2006/0205874 A1 (Uezz, et al.); and European Patent No. 1625178 B1 (Uzee et al.).

It is recognized that particular conversion processes (e.g., film and fiber) may favor particular compositional ranges, molecular weight ranges, and formulations. The preferences described in the prior art publications are incorporated by reference.

### Additional Polymer

In one or more embodiments, the low crystallinity polymer layer optionally comprises one or more additional polymers. The additional polymer can have the same or different crystal type from the high crystallinity polymer of the high crystallinity polymer layer. In an embodiment of the present invention, the additional polymer is more crystalline than the low crystallinity polymer. In some embodiments, the additional polymer forms 2-30 wt % of the total weight of the low crystallinity polymer layer. In some embodiments, the additional polymer forms 5-20 wt % of the total weight of the low crystallinity polymer layer. Examples of additional polymers include other ethylene polymers, such as LLDPE, HDPE, high pressure low density resin, Ziegler-Natta catalyzed polyethylenes, metallocene catalyzed polyethylenes, olefin block copolymers, materials made in multiple reactors (series or parallel), and combinations thereof. One embodiment uses a high pressure low density resin which has at least one enhanced processibility characteristic such as higher line speed without draw resonance, reduced neck-in of the melt, lower pressure, lower torque, and lower power consumption. Examples of additional polymers also include propylene polymers, such as homopolymer polypropylene, propylene-based random copolymers, propylene-ethylene copolymers, impact copolymers, high melt strength polypropylene, Ziegler-Natta catalyzed polypropylenes, metallocene catalyzed polypropylenes, materials made in multiple reactors (series or parallel), and combinations thereof. One embodiment uses a homopolymer polypropylene resin which has at least one enhanced processibility characteristic such as the ability to accelerate the crystallization rate of propylene-ethylene copolymers. Though not intended to be limited by theory, its is thought that the induced crystallization results in the faster development of mechanical properties (decreased aging effects) and reduced tackiness thereby allowing easy of handling and higher line-speeds.

Incorporation of higher crystallinity components such as LDPE and lower crystallinity in a given layer can have processibility and property advantages as described in PCT Published Application No. WO 2007/051103 (Patel, et al.).

### High Crystallinity Polymer Layer

The high crystallinity polymer layer has a level of crystallinity sufficient to permit yield and plastic deformation during elongation. The high crystallinity polymer layer comprises a high crystallinity polymer. The high crystallinity polymer layer optionally comprises a layer selected from the group consisting of a nonwoven layer, a woven fibrous layer, and a film layer. The high crystallinity polymer layer has a degree of crystallinity greater than 20%, and preferably greater than 25%.

In one embodiment, the high crystallinity polymer layer is in contact with the low crystallinity polymer layer. In one embodiment, the high crystallinity polymer layer is in contact with the additional layer.

### High Crystallinity Polymer

In one embodiment, the high crystallinity polymer comprises at least one of a homopolymer of ethylene, a copolymer of ethylene, and one or more comonomers selected from C₃-C₂₀ α-olefins. The ethylene homopolymer or copolymer has a density in the range of about 0.86 to about 0.95 g/cm³. Typically the ethylene copolymer has a comonomer content of greater than 10 mol %. In some embodiments, the copolymers are selected from the group consisting of ethylene/octene, ethylene/hexene, ethylene/butene, and ethylene/propylene with a density in the range of about 0.86 to about 0.95 g/cm³ and MI in the range of about 0.1 to about 30 g/10 minutes. In some embodiments, the copolymers are selected from the group consisting of ethylene/octene, ethylene/hexene, and ethylene/butene with a density in the range of about 0.86 to about 0.95 g/cm³ and MI in the range of about 0.1 to about 20 g/10 minutes. The high crystallinity polymer has a heat of fusion in the range of about 3 to about 50 J/g and a MWD in the range of about 2 to about 4.5.

In another embodiment, the high crystallinity polymer comprises at least one of a homopolymer of propylene, a copolymer of propylene, and one or more comonomers selected from ethylene and C₄-C₂₀ α-olefins. The propylene copolymer has a comonomer content of about 17 mol %. In some embodiments, the comonomer present in the propylene copolymer is ethylene. In some embodiments, the propylene copolymer comprises about 3 to about 16.5 wt % ethylene comonomer and has a MFR in the range of about 1 to about 25 g/10 minutes. In some embodiments, the propylene copolymer comprises about 9 to about 16.5 wt % ethylene comonomer and has a MFR in the range of about 1 to about 25 g/10 minutes.

In one embodiment, the high crystallinity polymer is plastically deformed upon elongation of the article. Plastic deformation of the high crystallinity polymer typically leads to an increase in haze value of the article. An increase in haze value can be used by one of average skill in the art to determine if an article has been plastically deformed. The increase in haze value is thought to originate from an increase in surface roughness. Surface roughness is thought to originate from differential recovery behavior after deformation. Upon deformation, the high and low crystallinity layers are thought to extend similarly but upon release, there is differential recovery behavior between the high and the low crystallinity layers. Lower tendency to recover (higher set) of the high crystallinity layer and the retractive force of the low crystallinity layer is thought to produce a mechanical instability and result in a surface that can be described as corrugated, micro-undulated, microstructured, micro-textured, and crenulated resulting in increased haze. Upon extension, haze can decrease as the surface roughness is reduced. Haze value is measured according to ASTM D1003 using a HazeGard PLUS Hazemeter (BYK Gardner; Melville, N.Y.), with a light source CIE Illuminant C. In some embodiments, plastically deformed articles may have a haze value of greater than about 70%. In some embodiments, plastically deformed articles may have a haze value of greater than about 80%. In some embodiments, plastically deformed articles may have a haze value of greater than about 90%.

The terms “recover”, “recovery”, and “recovered” are used interchangeably and refer to a contraction of a stretched material upon termination of a stretching force following stretching of the material by application of the stretching force. Recovery can be measured in terms of strain. Percent recovery (% Recovery) is defined by Equation 2:

$$\% Recovery = \frac{{ɛ}_{f} - {ɛ}_{s}}{{ɛ}_{f}} \times 100 , \qquad ( Eq . 2 )$$

where ε_{f} is the strain taken for cycling loading and εₛ is the strain where the load returns to the baseline during the subsequent unloading cycle. For example, a material taken to 300% strain (ε_{f}=300%) that returns to 150% (εₛ=150%, permanent set=150%) has a % Recovery=(300%−150%)/(300%)×100=50%.

In one embodiment, the high crystallinity polymer comprises at least one of succinic acid and succinic anhydride moieties.

In one embodiment, the high crystallinity polymer comprises at least one of a Ziegler-Natta, a metallocene, and a single site polyolefin made using a Ziegler-Natta type catalyst, a metallocene type catalyst, and a single site catalyst, respectively.

The high crystallinity polymer may be produced by any process that provides the desired polymer properties. These polymers can comprise materials known as HDPE, LLDPE, LDPE, medium density polyethylene (MDPE), ultra-low density polyethylene (ULDPE), hPP, high crystallinity polypropylene (HCPP), random copolymer polypropylene (RCPP), and other copolymers including plastomers and elastomers.

As previously discussed, ethylene copolymers with elastic property are commercially available as AFFINITY™ PL 1880G polyolefin plastomer from Dow and EXACT™ from Exxon-Mobil. Propylene copolymers with elastic property are commercially available as VERSIFY™ 2300 elastomer from Dow and VISTAMAXX™ from Exxon-Mobil. Formulations comprising developmental propylene-based plastomers and elastomers from Dow may also be used. Olefinic block copolymers (as described in PCT Published Application Nos. WO 2005/090427, WO 2005/090426, and WO 2005/090425 (Arriola, et al.) and U.S. Pat. No. 7,355,089) can also be used as the high crystallinity polymer.

### The Article

In one embodiment, an elastic article in the form a laminate comprises at least one low crystallinity polymer layer and optionally a high crystallinity polymer layer. The low crystallinity polymer layer comprises a low crystallinity polymer and optionally an additional polymer. The high crystallinity polymer layer comprises a high crystallinity polymer.

In another embodiment, an article in the form of a laminate having at least two layers comprising at least a low crystallinity polymer layer and a high crystallinity polymer layer.

In some embodiments, the high crystallinity polymer has a melting point, as determined by DSC, less than about 50° C. above the melting point of the low crystallinity polymer. In some embodiments, the high crystallinity polymer has a melting point, as determined by DSC, less than about 25° C. above the melting point of the low crystallinity polymer. In some embodiments, the high crystallinity polymer has a melting point, as determined by DSC, less than about the melting point of the low crystallinity polymer. In some embodiments, the high crystallinity polymer has a melting point, as determined by DSC, less than and within 50° C. of the melting point of the low crystallinity polymer. In an embodiment, the melting point of the high crystallinity polymer is within about 25° C. of the melting point of the low crystallinity polymer.

In another embodiment, an article in the form of a laminate has at least one additional layer apart from a low crystallinity polymer layer and a high crystallinity polymer layer. In an embodiment, the additional layer is more crystalline than the low crystallinity polymer layer. In another embodiment, the additional layer is less crystalline than the low crystallinity polymer layer.

In another embodiment, an article in the form of a laminate has at least one additional layer, comprising at least a non-skin layer apart from a low crystallinity polymer layer and a high crystallinity polymer layer. The term “non-skin layer” refers to a layer which is not any of the surface layers of the article. In one embodiment, the non-skin layer comprises a low crystallinity polymer. In another embodiment, the non-skin layer comprises a high crystallinity polymer.

In some embodiments, the article may be elongated in at least one direction to an elongation of at least 50% of its original length or width. In some embodiments, the article may be elongated in at least one direction to an elongation of at least 100% of its original length or width. In some embodiments, the article may be elongated in at least one direction to an elongation of at least 150% of its original length or width. The elongation step is carried out at a temperature below the melting point of the low crystallinity polymer and the high crystallinity polymer. This elongation step may be accomplished by any means known to those skilled in the art; however, they are particularly suited for MD or CD orientation activation methods including ring-rolling, selfing, MD orientation, and stretch-bonded lamination processes.

The article may be referred to as a “pre-stretched article” in the context that the article may again be elongated in its ultimate use, e.g., packaging, shipping, hygiene applications. In one embodiment, the elongation may be performed on the entire article. In another embodiment, the elongation may also be performed separately on the individual layers of the article before lamination. In one embodiment, the elongation may be performed on the entire laminate of the article. In another embodiment, this step can also be performed on the individual layers of the article before lamination.

In an embodiment, the pre-stretched article of the present invention is heat-shrunk at a temperature not greater than 10° C. above the melting point of the low crystallinity polymer. Heat shrinking leads to a reduction in the permanent set of the pre-stretched article by at least about 25%. In some embodiments, heat shrinking is performed at a temperature between 30° C. and within about 10° C. of the melting point of the low crystallinity polymer. As measured using DSC, during the heat shrinking processes, 30% or less, by weight, melted crystals are present in the low crystallinity polymer.

In one embodiment, the low crystallinity polymer and the high crystallinity polymer have a density less than about 0.88 g/cm³ as measured using ASTM method D792. In one embodiment, the low crystallinity polymer and the high crystallinity polymer can co-crystallize. This typically occurs for polymers that have the same crystal type (i.e., polyethylene crystallinity or polypropylene crystallinity) and that have crystallinities within 20 wt % of each other.

In another embodiment, one polymer can induce the crystallization of another other polymer such as in the case of epitaxial crystallization. In one aspect, the low crystallinity polymer (i.e., the polymer has crystallinity of less than or equal to 50 wt %) and the high crystallinity polymer (i.e., the polymer has crystallinity of greater than about 50 wt %) and one polymer induces the crystallization of the other. In another embodiment, one polymer of dissimilarly crystal type can induce the crystallinity of the other polymer. In one embodiment, the crystallization of polypropylene crystals can function as sites for epitaxial crystallization of polyethylene crystals. In another embodiment, the crystallization of polyethylene crystals can function as sites for epitaxial crystallization of polypropylene crystals. In another aspect, the low crystallinity polymer and the high crystallinity polymer may have similar stereo-regular sequences. Two polymers are said to have similar stereo-regular sequences when they are either both isotactic or both syndiotactic. The advantages of interactions between crystallization behaviors among different polymers sometimes called “compatible crystallinities” include but are not limited to enhanced crystallization, higher crystallization rates, faster development of elasticity, enhanced processibility (i.e., line-speed), faster development of toughness/tear resistance/puncture resistance, adhesion, other mechanical properties, optical properties, heat resistance, and other solid-state and conversion characteristics. Though not intended to be limited by theory, it is thought that such behavior is particularly advantageous in melt processing steps used to convert polymeric compositions into a variety of products including by not limited to films, fibers, nonwovens, laminates, scrims, and adhesive layers/patterns.

In one embodiment, the low crystallinity polymer and the high crystallinity polymer have a weight percent crystallinity difference of at least about 1%. The weight percent crystallinity difference may be as high as about 65%. The method for measuring weight percent crystallinity is described in the Experiments section.

In one embodiment, the low crystallinity polymer comprises at least about 45% of the combined weight of the low and the high crystallinity polymers in the article. In one embodiment, the low crystallinity polymer comprises at least about 50% of the combined weight of the low and the high crystallinity polymers in the article. In one embodiment, the low crystallinity polymer comprises at least about 60% of the combined weight of the low and the high crystallinity polymers in the article.

In one embodiment, the high crystallinity polymer comprises less than about 20% of the combined weight of the low and high crystallinity polymers. In another embodiment, the high crystallinity polymer comprises less than about 15% of the combined weight of the low and high crystallinity polymers. In another embodiment, the high crystallinity polymer comprises less than about 10% of the combined weight of the low and high crystallinity polymers.

In an embodiment, at least one of the low crystallinity polymer layer and the high crystallinity polymer layer comprises at least one of a nonwoven layer, a woven fibrous layer, and a film layer.

In one embodiment, the article is in the form of fibers. In an embodiment, the fibers form a web. In some embodiments, at least a portion of the fibers forming the web are bonded to each other. In another embodiment, the article is in the form of a web comprising bicomponent fibers. One or both of the low crystallinity polymer and the high crystallinity polymer comprise at least a portion of the bicomponent fiber. The bicomponent fibers may have configuration such as sheath/core, side-by-side, crescent moon, trilobal, islands-in-the-sea, and flat.

In one embodiment, at least one layer of the article comprises an additive selected from the group, but not limited to, inorganic fillers such as calcium carbonate, talc, mica, silicon dioxide, clays, titanium dioxide, carbon black, and diatomaceous earth, pigments and colorants, oils, waxes, tackifiers, polymer chain extenders, antiblocks, slip additives, foaming and blowing agents, surfactants, antioxidants, cross-linking and grafting agents, and nucleating agents for enhancing crystallization rates. Other components that may be added to the at least one layer of the article include dual reactor materials, SEBS (styrene-ethylene-butylene-styrene) block-copolymers available from KRATON Polymers LLC. (Houston, Tx), ethylene vinyl acetate (EVA) copolymers, ethylene acrylic acid (EAA) copolymers, ethylene carbon monoxide (ECO) copolymers, thermoplastic polyurethane (TPU), and other elastomeric components.

In one embodiment, the article is in the form of a cross-linked film. In one aspect, at least one layer of the article, which may comprise a film or a fiber, does not have a distinct melting point.

In the practice of some of the embodiments, curing, irradiation, or cross-linking of the elastic polymers, elastic polymer compositions, or articles comprising elastic polymers or elastic polymer compositions can be accomplished by any means known in the art, including, but not limited to, electron-beam irradiation, beta irradiation, X-rays, gamma irradiation, controlled thermal heating, corona irradiation, peroxides, allyl compounds and UV radiation with or without cross-linking catalyst. Electron-beam irradiation is one means for cross-linking the substantially hydrogenated block polymer or the shaped article comprised of the substantially hydrogenated block polymer. IN some embodiments, the curing, irradiation, cross-linking or combination thereof provides a percent gel of greater than or equal to 40 wt %. In some embodiments, the curing, irradiation, cross-linking or combination thereof provides a percent gel of greater than or equal to 50 wt %. In some embodiments, the curing, irradiation, cross-linking, or combination thereof provides a percent gel of greater than or equal to 70 wt %. Xylene extractables (and gel content) are determined in accordance with ASTM D-2765.

Cross-linking can be promoted with a cross-linking catalyst, and any catalyst that will provide this function can be used. Suitable catalysts generally include organic bases, carboxylic acids, and organometallic compounds, including organic titanates and complexes or carboxylates of lead, cobalt, iron, nickel, zinc, and tin. Examples include, but are not limited to dibutyltindilaurate, dioctyltinmaleate, dibutyltindiacetate, dibutyltindioctoate, stannous acetate, stannous octoate, lead naphthenate, zinc caprylate, and cobalt naphthenate. Tin carboxylate, especially dibutyltindilaurate and dioctyltinmaleate, have been found particularly effective. The catalyst (or mixture of catalysts) is present in a catalytic amount, typically between 0.015 and 0.035 lbs/hour (0.007 and 0.016 kgs/hour). In addition, additional chemical agent or agents can be used to enhance crosslinking known to those of normal skill in the art. Included in these crosslinking enhancing agents are the class of materials known as “co-agents”. Suitable co-agents that can be used for this purpose include but are not limited to multifunctional compounds such as triallyl cyanurate and triallyl isocyanurate.

Crosslinking can have various benefit including but not limited to heat resistance, tensile strength at elevated temperatures, resistance to hydrolysis weathering resistance, and resistance to oil.

### Low Crystallinity Polymer Layer

The low crystallinity polymer layer is sufficiently elastic to allow extension of the high crystallinity polymer layer to and beyond a point of plastic deformation. During the elongation step, the low crystallinity polymer layer elongates without substantial loss of its ability to recover upon release. The low crystallinity polymer layer comprises the low crystallinity polymer and optionally at least one additional polymer.

In one embodiment, the low crystallinity polymer comprises an elastomer.

The low crystallinity polymer layer may comprise at least one layer selected from the group consisting of a fiber layer, a nonwoven fabric layer, a woven fibrous layer, a film layer, and a tape layer. The low crystallinity polymer layer may have a degree of crystallinity of up to about 20 wt %.

In one embodiment, the low crystallinity polymer layer is in contact with the high crystallinity polymer layer. In one embodiment, the high crystallinity polymer layer is in contact with the additional layer.

### Applications of the Article

Embodiment articles may be used in a variety of applications such as hygiene and medical applications. The article may be incorporated in diapers, waistbands, leg openings, shower caps, food container caps, car covers, medical gowns, medical drapes, disposable clothing, and other health and hygiene articles.

Further examples of some specific applications include, diaper backsheets, feminine hygiene films, elastic strips, and elastic laminates in gowns and sheets. The article of the present invention may be adhered to a garment substrate comprising a garment portion, preferably a diaper backsheet, and/or an elastic tab.

In one embodiment, the article comprises blown film, the MI of the polymer used in the blown film is generally at least about 0.5 g/10 minutes. In some embodiments, the MI of the polymer used in the blown film is generally at least about 0.75 g/10 minutes. In some embodiments, the MI of the polymer is generally at most about 5 g/10 minutes. In some embodiments, the MI of the polymer is generally at most about 3 g/10 minutes.

In another embodiment, the article comprises cast film and/or extrusion laminate processes. The melt index (I₂) of the interpolymer is generally at least about 0.5 g/10 minutes, preferably at least about 0.75 g/10 minutes, more preferably at least about 3 g/10 minutes, even more preferably at least about 4 g/10 minutes. The melt index (I₂) is generally at most about 20 g/10 minutes, preferably at most about 17 g/10 minutes, more preferably at most about 12 g/10 minutes, even more preferably at most about 5 g/10 minutes.

In another embodiment, at least one layer comprises an ethylene/α-olefin interpolymer. In some embodiments, the ethylene/α-olefin interpolymer is made with a diethyl zinc chain shuttling agent where the mole ratio of zinc to ethylene is in the range of about 0.03×10⁻³ to about 1.5×10⁻³.

In one embodiment, the article comprises a fiber. The fiber may be in monocomponent form, bicomponent form, or multicomponent form. In another embodiment, the article comprises a woven fabric. In yet another embodiment, the article comprises a non-woven fabric. In another embodiment, the article comprises at least one nonwoven from the group: melt blown, spunbond, carded web, spunlaced, hydroentangled, needle-punched, and airlaid nonwoven. In another embodiment, the article comprises at multiple nonwovens including but not limited to spunbond-melt blown (SM) and SMxS such that ‘x’ is an integer greater than or equal to 1.

The embodied articles are compatible with a variety of elastic laminate designs, however they are particularly suited for MD and CD orientation elongation methods including ring-rolling, selfing, CD orientation, MD orientation, and stretch-bonded lamination process. The elongation process is also compatible in use with elastic nonwovens.

All patents, test procedures, and other documents cited, including priority documents, are fully incorporated by reference to the extent such disclosure is not inconsistent with this invention and for all jurisdictions in which such incorporation is permitted. Such incorporation includes the definitions, methods, synthetic chemical reactions, compositions, formulations, molecular weights, thermal properties, melt characteristics, phase structures, solid-state structures, mechanical characteristics, formulations, methods of compounding, methods of processing, and preferred operating ranges and material specifications.

While the illustrative embodiments have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth but rather that the claims be construed as encompassing all the features of patentable novelty which reside in the present invention, including all features which would be treated as equivalents thereof by those skilled in the art to which the invention pertains.

When numerical lower limits and numerical upper limits are listed, ranges from any lower limit to any upper limit are contemplated. Depending upon the context in which such values are described, and unless specifically stated otherwise, such values may vary by 1 percent, 2 percent, 5 percent, or, sometimes, 10 to 20 percent. Whenever a numerical range with a lower limit, RL and an upper limit, RU, is disclosed, any number falling within the range is specifically disclosed. In particular, the following numbers within the range are specifically disclosed: R═RL+k*(RU−RL), where k is a variable ranging from 0.01 to 1.00 with a 0.01 increment, i.e., k is 0.01 or 0.02 to 0.99 to 1.00. Moreover, any numerical range defined by two R numbers as defined in the above is also specifically disclosed.

As used in the description and in the claims, the term “comprising” is inclusive or open-ended and does not exclude additional unrecited elements, compositional components, or method steps. Accordingly, such terms are intended to be synonymous with the words “has”, “have”, “having”, “includes”, “including”, and any derivatives of these words.

### EXAMPLES

### Comonomer Content

Comonomer content may be measured using any suitable technique, such as techniques based on nuclear magnetic resonance (NMR) spectroscopy. Moreover, for polymers or blends of polymers having relatively broad TREF curves, the polymer desirably is first fractionated using TREF into fractions each having an eluted temperature range of 10° C. or less. That is, each eluted fraction has a collection temperature window of 10° C. or less. Using this technique, the block interpolymers have at least one such fraction having a higher molar comonomer content than a corresponding fraction of the comparable interpolymer.

### Density Measurement Method:

Coupon samples (1 inch×1 inch×0.125 inches of polymer) (25.4 mm×25.4 mm×3.18 mm) were compression molded at 190° C. according to ASTM D4703-00, cooled to 40-50° C. and removed. Once the sample reaches 23° C., its dry weight and weight in isopropanol are measured using an Ohaus AP210 balance (Ohaus Corporation; Pine Brook, N.J.). Density is calculated as prescribed by ASTM D792, procedure B.

### Melt Flow Properties (ASTM D1238 (1995)):

MI for polymers in which ethylene comprises the majority component by molarity is determined according to ASTM D1238, “Standard Test Method for Melt Flow Rates of Thermoplastics by Extrusion Plastometer”, using a weight of 2.16 kg at 190° C. MFR for polymers in which propylene comprises the majority component is determined according to ASTM D1238, using a weight of 2.16 kg at 230° C. MFR values greater than about 250 g/10 minutes are estimated according to Equation 3:

MFR=9×10¹⁸ Mw^{-3.584} (Eq. 3),

where weight averaged molecular weight, M_{w} (g/mole), is measured using gel permeation chromatography.

### DSC Method:

DSC is a common technique that can be used to examine the melting and crystallization of semi-crystalline polymers. General principles of DSC measurements and applications of DSC to studying semi-crystalline polymers are described in standard texts (e.g., E. A. Turi, ed., Thermal Characterization of Polymeric Materials, Academic Press, 1981). DSC is a method suitable for determining the melting characteristics of a polymer. For oriented systems such as fiber in which crystallinity is substantially different from the unoriented polymer, x-ray diffraction is more suitable.

DSC analysis uses a model Q1000 DSC from TA Instruments, Inc. (New Castle, Del.). The DSC is calibrated by the following method. First, a baseline is obtained by running the DSC from −90° C. to 290° C. without any sample in the aluminum DSC pan. Next, 7 milligrams of a fresh indium sample is analyzed by heating the sample to 180° C., cooling the sample to 140° C. at a cooling rate of 10° C./minute followed by keeping the sample isothermally at 140° C. for 1 minute, followed by heating the sample from 140° C. to 180° C. at a heating rate of 10° C./minute. The heat of fusion and the onset of melting of the indium sample are determined and checked to be ±0.5° C. of 156.6° C. for the onset of melting and ±0.5 J/g of 28.71 J/g for the heat of fusion. Then deionized water is analyzed by cooling a small drop of fresh sample in the DSC pan from 25° C. to −30° C. at a cooling rate of 10° C./minute. The sample is kept isothermally at −30° C. for 2 minutes and heated to 30° C. at a heating rate of 10° C./minute. The onset of melting is determined and checked to be ±0.5° C. of 0° C.

Polymer samples are pressed into a thin film at an initial temperature of 190° C. (designated as the “initial temperature”). About 5 to 8 mg of sample is weighed out and placed in the DSC pan. The lid is crimped on the pan to ensure a closed atmosphere. The DSC pan is placed in the DSC cell and then heated at a rate of about 100° C./minute to a temperature (Tₒ) of about 60° C. above the melt temperature of the sample. The sample is kept at this temperature for about 3 minutes. Then the sample is cooled at a rate of 10° C./minute to −40° C., and kept isothermally at that temperature for 3 minutes. The sample is then heated at a rate of 10° C./minute until complete melting. Enthalpy curves resulting from this experiment are analyzed for peak melt temperature, onset and peak crystallization temperatures, heat of fusion and heat of crystallization, and any other DSC analyses of interest.

Residual crystallinity is a measure of the crystallinity of a material at a given temperature. It is measured by integrating the aforementioned DSC enthalpy curve (described previously) from the temperature of interest to 190° C. to give the residual heat of fusion. The residual heat of fusion is divided by the heat of melting for the 100% crystalline material to determine the residual crystallinity at that particular temperature. Residual crystallinity calculated for a variety of temperatures can be used to construct a residual crystallinity versus temperature curve.

For a polymer comprising polypropylene crystallinity is analyzed, Tₒ, is 230° C. Tₒ is 190° C. when polyethylene crystallinity is present and no polypropylene crystallinity is present in the sample.

Percent crystallinity by weight is calculated according to Equation 4:

$$Crystallinity ( wt \% ) = \frac{Δ H}{Δ {H}_{o}} \times 100 \% , \qquad ( Eq . 4 )$$

where the heat of fusion (□H) is divided by the heat of fusion for the perfect polymer crystal (□Hₒ) and then multiplied by 100%. For ethylene crystallinity, the heat of fusion for a perfect crystal is taken to be 290 J/g. For example, an ethylene-octene copolymer which upon melting of its polyethylene crystallinity is measured to have a heat of fusion of 29 J/g; the corresponding crystallinity is 10 wt %. For propylene crystallinity, the heat of fusion for a perfect crystal is taken to be 165 J/g. For example, a propylene-ethylene copolymer which upon melting of its propylene crystallinity is measured to have a heat of fusion of 20 J/g; the corresponding crystallinity is 12.1 wt %.

### X-Ray Experimental:

To determine crystallinity of an oriented system in which the crystallinity is substantially different from the polymer in its unoriented state such as in fibers (i.e. spunbond, melt blown, staple) or oriented films (i.e. blown film, cold drawn, MDO, ring-rolled, biaxially oriented film), X-ray diffraction is more suitable. The samples are analyzed using a GADDS system from Bruker-AXS (Madison, Wi), with a multi-wire two-dimensional HiStar detector. Samples are aligned with a laser pointer and a video-microscope. Data are collected using copper K_{□} radiation with a sample to detector distance of 6 cm. The X-ray beam is collimated to 0.3 mm.

### Data Analysis:

Crystallinity from X-ray diffraction is normally determined by profile fitting with software. Jade software from Materials Data, Inc. (Livemore, Calif.) was used for this evaluation. Crystallinility index, instead of crystallinity, is provided due to the nature of oriented structure. For a polymer system with a relatively high crystallinity, such a crystallinity index can be easily and accurately obtained with an integrated and averaged diffraction profile over different azimuthal angle.

Conventionally, the scattering area from amorphous segments and the diffraction area from crystals can be determined by profile fitting of the integrated diffraction profile, such as, with Jade software. Then the crystallinity index can be calculated based on these two area values. However, for highly elastic fibers, the crystallinity is relatively low and the diffraction peaks are not well defined. Therefore, profile fitting would not provide a reliable value of amorphous scattering area for calculation of crystallinity index.

In these examples, an alternative method is used. Total diffraction and scattering area is still obtained in a conventional way by integrating the total diffraction and scattering area of the profile after background subtraction. However, the amorphous scattering is not determined from the averaged diffraction profile by profile fitting. Amorphous scattering in two extreme directions, fiber direction and in near equatorial direction (10 degree off from equatorial direction) are well defined for such highly oriented fibers and can be easily obtained by profile fitting. An average amorphous scattering area from these two extreme directions was then used for the calculation of crystallinity index, X_{c}.

With this method, the amorphous scattering area can be more accurately determined for such a fiber system. By using this average amorphous scattering area and the total diffraction/scattering area determined for the integrated profile over 360 degrees, a reliable X_{c}, could be determined. The validity of this method was validated for fibers with intermediate crystallinity. The amorphous orientation was obtained by the ratio of amorphous scattering area in fiber direction to that in near equatorial direction (10 degree off from equatorial direction, so that well-defined amorphous scattering profile can be obtained). Based on this definition, 0 represents perfect amorphous orientation, and 1 represents random orientation. Wilchinsky's method was used for the calculation of crystal orientation along the fiber direction. The calculated fc represents how the chains in the crystal are aligned in fiber direction with 1 representing perfect orientation, 0 representing random orientation, and −0.5 representing perfectly perpendicular orientation.

### Gel Permeation Chromatography

Molecular weight distribution of the polymers is determined using gel permeation chromatography (GPC) on a Polymer Laboratories PL-GPC-220 high temperature chromatographic unit (Amherst, Mass) equipped with four linear mixed bed columns (Polymer Laboratories (20-micron particle size)). The oven temperature is at 160° C. with the autosampler hot zone at 160° C. and the warm zone at 145° C. The solvent is 1,2,4-trichlorobenzene containing 200 ppm 2,6-di-t-butyl-4-methylphenol. The flow rate is 1.0 mL/minute and the injection size is 100 μL. About 0.2% by weight solutions of the samples are prepared for injection by dissolving the sample in nitrogen-purged 1,2,4-trichlorobenzene containing 200 ppm 2,6-di-t-butyl-4-methylphenol for 2.5 hours at 160° C. with gentle mixing.

The molecular weight determination is deduced by using ten narrow molecular weight distribution polystyrene standards (from Polymer Laboratories, EasiCal PS1 ranging from 580-7,500,000 g/mole) in conjunction with their elution volumes. The equivalent polypropylene molecular weights are determined by using Mark-Houwink coefficients for polypropylene (as described by Th. G. Scholte, N. L. J. Meijerink, H. M. Schoffeleers, and A. M. G. Brands, J. Appl. Polym. Sci., 29, 3763-3782 (1984)) and polystyrene (as described by E. P. Otocka, R. J. Roe, N.Y. Hellman, P. M. Muglia, Macromolecules, 4, 507 (1971)) in the Mark-Houwink equation, as given in Equation 5:

{N}=KM^{a} (Eq. 5),

where for polypropylene Kₚₚ=1.90E-04 and aₚₚ=0.725 and for polystyrene Kₚₛ=1.26E-04 and aₚₛ=0.702.

### Pre-Stretch Heat Shrink Test:

Microtensile test specimens are cut from the film using a NAEF punch press (Bolton Landing, N.Y.) fitted with an ASTM D1708 microtensile die aligned parallel to the MD or CD. The sample is loaded into an INSTRON 5564 (Norwood, Mass.) fitted with a 100 N load cell. The crosshead is extended at a rate of 333%/minute (74.1 mm/minute) to a pre-stretched strain of 100 (22.25 mm extension), 300 (66.75 mm extension), or 500% (111.25 mm extension). Then the crosshead is returned at the same rate to the position corresponding to 0% strain. Immediately, the sample is removed and placed unconstrained on a low friction surface at ambient conditions (20° C., 50% relative humidity). Ten minutes is allowed to elapse for the sample to recover, then the sample length between the tabs is measured. The strain is calculated relative to the original length (22.25 mm). This strain is designated as the “initial permanent set”.

Next, the sample is stretched to 50, 100, or 150% strain (1^{st} stretch strain) at a rate of 333%/minute, returned to 0% strain, and extended once again to the 1^{st} stretch strain at the same rate. The onset of positive load during the second extension of the 1^{st} stretch is designated as the “permanent set”. Permanent set is taken as the onset of positive stress (tensile load) upon reloading after the first stretch.

Next, the sample is placed on Teflon™ sheets and then placed into a convection oven (General Signal Company; Stamford, Conn.) pre-heated to a set temperature for one minute. Afterwards, the sample is remove and allowed to cool to ambient conditions (20° C., 50% relative humidity). The length of the shrunken sample is then measured in order to calculate the strain. This strain is designated as the “post-shrink permanent set”.

### Method of Preparation of the Article

The present invention includes a process for making an elastic article. The process includes forming an article, where the article comprises a low crystallinity polymer layer and optionally a high crystallinity polymer layer. The process further includes a pre-stretching and a heat shrinking step for making the final elastic article. As used, the term “pre-stretching” refers to an elongating step performed prior to heat shrinking.

Compositions for the low crystallinity polymer and the high crystallinity polymer used in the invention comprise at least one of an ethylene based polymer, and a propylene based polymer. The ethylene based polymer can have a density in the range of about 0.86-0.88 g/cm³). Ethylene based polymers are commercially available as AFFINITY™ PL 1880G Polyolefin Plastomer from Dow Chemical. The ethylene based polymers used in the invention are shown in Table 1. The propylene based polymer can have a monomer content in the range of 10-15 wt. %. Propylene-based elastomers are commercially available as VERSIFY™ 2300 elastomer from Dow Chemical. Propylene-based polymers used are shown in Table 2. Grades A-D are metallocene based polymers, while grades E and F are propylene-ethylene elastomers. Styrene-based polymer compositions used in the low crystallinity polymer are shown in Table 3.

TABLE 1
Ethylene based polymer compositions

| | | Density | MI |
|---|---|---|---|
| Designation | Description | (g/cm³) | (g/10 min) |
| A | ethylene-octene | 0.87 | 1 |
| B | ethylene-octene | 0.864 | 13 |
| C | ethylene-octene | 0.863 | 2.5 |
| D | ethylene-octene | 0.857 | 1 |

TABLE 2
Propylene based polymer compositions

| | | Ethylene | MFR |
|---|---|---|---|
| Designation | Description | wt. % | (g/10 min) |
| E | propylene-ethylene | 11.1 | 2 |
| F | propylene-ethylene | 13.2 | 2 |

TABLE 3
Styrene based polymer compositions

| Designation | Grade | Description |
|---|---|---|
| G | G-1657^{a} | SEBS |
| H | G-1652^{a} | SEPS |
| I | Vector 4111A^{b} | SBS |

^{a}available from Kraton Polymers LLC (Houston, Tx)
^{b}available from Dexco Polymers LP (Houston, Tx)

The blends of the low crystallinity polymer and the high crystallinity polymer can be prepared by any procedure that guarantees an intimate mixture of the components. Commercially available techniques known in the art for the preparation of blends are dry blending, melt compounding, side arming, and solution blending.

Examples of the forms that the polymer blend can be converted into include but are not limited to, a film, a fiber, a nonwoven and a tape. It can then be assembled into composite structures such as a laminate and a yarn. An embodiment would be a multilayer laminate with at least one nonwoven layer. The nonwoven layer can be non-elastic, extensible, or elastic. In an embodiment, the melting point of the nonwoven layer may be higher than the temperature at which the heat-shrinking is performed, in order to avoid melting of the fibers in the nonwoven layer.

An embodiment comprises an “elastic nonwoven”. Particularly suitable structures are described based on the test methods and specification of U.S. Pat. No. 5,997,989 (Gessner, et al.).

The film can be incorporated in a laminate structure such as spunbond facings. The structure of the spunbond facing can be modified for extensibility (i.e., neck bonded laminate process) prior to incorporation into the laminate for the purpose of elasticity. Elasticity can also be introduced after lamination such as in the ring rolling process or, if an inherently elastic or extensible spunbond is used, then an activation step may not be necessary.

Assembly of the laminate structure can be done by introduction of melt form, semi-solid form, and solid form of the polymer blend onto other components such as a nonwoven layer. In one method, this can be done by coating the polymer blend onto nonwoven layers. In another method, this can be done by adhesive lamination of the polymer blend onto the nonwoven layers. In another method, this can be done by combinations of the previously described processes. Other examples of compatible methods include ultrasonic bonding, hydraulic needling, needle punching, and calendar roll bonding.

In an embodiment, the article can be co-extruded in multilayer structures. For improved resistance to draw resonance, such articles are typically extruded with skin layers comprising a branched species such as LDPE and EVA polymer. If additional tear resistance is desired, the skin layer may also comprise LLDPE. Higher crystalline skin layers may also facilitate aperture formation in the case that breathability is desired. The skin layers may also comprise species with lower melting behavior that the core which impart heat sealability to other components such as a nonwoven layer. Other examples may include skin layers for enhanced feel, opacity, hydrophilicity, and hydrophobicity.

The lamination process may also be practiced with the process described in PCT Published Application No. WO 1999/017926 (Thomas, et al.). In this process, an elastomer is stretched and held in the stretched position during lamination with nonwovens. The laminate is then released from the stretched position in order to produce a corrugated nonwoven structure. Introduction of a heating step after the lamination and release will decrease this difference in performance. This occurs because the “stretch to stop (STS)” (i.e. the elastic limit before the spunbond layer takes over the stress-elongation behavior) of a SBL (stretch bonded laminate) is determined by the amount of retraction after release. Increasing the amount of retraction by heat increases the STS in polyolefin-based SBL. In an embodiment, at least one of the low crystallinity polymer and the high crystallinity polymer are plastically deformed in case of SBLs.

In an embodiment, the article comprises a film, which is plastically deformed. In some embodiments, the plastically deformed film has a haze value of greater than about 70%. In some embodiments, the plastically deformed film has a haze value of greater than about 80%. In some embodiments, the plastically deformed film has a haze value of greater than about 90%. Though not limited by theory, it is thought that the haze originates from a microtextured or microstructured skin layer which scatters and disperses light as described in U.S. Pat. No. 5,344,691 (Hanschen, et al.).

The elongation step is carried out at a temperature below the melting point of the low crystallinity polymer and the high crystallinity polymer. Elongation of the structure assembly can be done by methods like ring-rolling, MD (machine direction) orientation, CD (cross direction) orientation, and combinations thereof. This can be done to each individual layer of the article prior to assembly or to the structure after assembly. In some embodiments, the structure assembly can be elongated in at least one direction to an elongation of at least 150% of its original length or width. In some embodiments, the structure assembly can be elongated in at least one direction to an elongation of at least 200% of its original length or width. In an embodiment, where the article comprises a film, the elongation step is performed until the film achieves a haze value of greater than 0%. In some embodiments, the elongation step is performed until the film achieves a haze value of greater than at least 10%. In some embodiments, the elongation step is performed until the film achieves a haze value of greater than at least 25%. In some embodiments, the elongation step is performed until the film achieves a haze value of greater than at least 50%.

Heat shrinkage of the elongated structure can be done by using different heat sources such as heated forced air, heated rolls (i.e., calendar or chrome-surfaced rolls), liquid bath, radio waves, and lamps (such as infra red or ultra violet). In a method using heated rolls, at least one surface of the elastomer is exposed to the heat shrinking processes. Heat shrinkage by forced air can be used for laminated structures with the elastomer layer positioned below the surface layer of the laminated structure. Laminated structures with apertures would be particularly suited for heat shrinkage by forced air. Heat shrinkage using liquid bath can be used in both cases, when the elastomer layer is exposed and when it is beneath another component or layer. The advantage of this method is the rapid transfer of heat through convection. In order to remove excess liquid left after this process, additional means such as wiper roll, forced air, and other heat sources such as lamps can be used. Radiation method can be used if the elastomeric formulation comprises a component that would increase in temperature upon exposure to radiation. Examples of such components include PVC, metals, metal oxides, and other radiation sensitive materials. Commercially available radiation methods include usage of gamma radiation, radio waves, and microwave radiation. In some embodiments, the heat-shrinking step is performed at a temperature between 30° C. and within about 10° C. of the melting point of the low crystallinity polymer.

The laminate structure is then cooled to stabilize the heat-shrunk structure. Stabilization occurs in a semi-crystalline material by crystallization and by the increase in viscosity of the amorphous phase. The laminate structure can be cooled by keeping it under ambient conditions. In another embodiment, the laminated structure can also be actively cooled by means such as forced air, cold chill roll, cold liquid, and by vacuum evaporation of a solvent.

The method used to prepare the inventive and comparative examples is as follows. Compression molded films of the low crystallinity and the high crystallinity polymer compositions are prepared by weighing out the necessary amount of polymer compositions to fill a 9 inch long by 6 inch (228.6 mm by 152.4 mm) wide by 0.1-0.5 millimeter deep mold. This polymer composition and the mold are lined with Mylar film and placed between chrome coated metal sheets. The assembly is then placed in a PHI laminating press model PW-L425 (City of Industry, Cal.). The laminating press is preheated to 190° C. for ethylene-based elastomers and to 210° C. for propylene-based elastomers. The polymer composition is allowed to melt for 5 minutes under minimal pressure. Then a force of 10000 pounds is applied for 5 minutes after which, the force is increased to 20000 pounds and one minute is allowed to elapse. Afterwards, the assembly is placed between 25° C. water-cooled platens and cooled for 5 minutes. The polymer structure is then removed from the mold and allowed to age at ambient conditions (about 25° C.) for at least 24 hours before testing for ethylene-based elastomers and for at least 48 hours before testing for propylene-based elastomers. Six inch long by 1 inch wide strips are cut from the compression molded film using a NAEF punch press.

For pre-stretching and subsequent testing, an INSTRON 5564 fitted with a 1 kN load cell and attached by rods to pneumatic grips fitted with flat grip facings. The grip facing separation is set to 22.25 mm corresponding to the narrow portion of the ASTM D1708 geometry. The ASTM D1708 microtensile specimens are inserted into the grips such that the specimen length is parallel to the direction of crosshead displacement. Air pressure for the pneumatic grips is adjusted to prevent slippage during testing. Typically, this was about 4.1 bar (60 psi). Next, a strain is applied at 333%/minute (74.09 mm/min extension rate) using the tensile method described earlier to pre-stretch the film and the laminate prior to heat-shrinkage. The applied strain is an experimental variable primarily determined by other application constraints such as rupture of nonwovens, rupture of film, machine constraints, and performance needs. In principle, the film or the laminate may be stretched to any strain up to break.

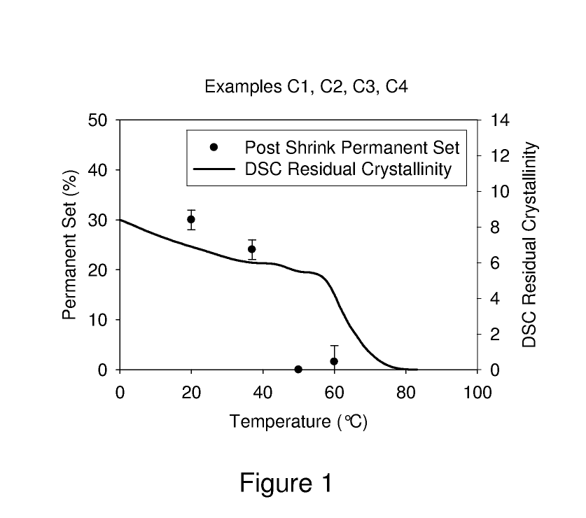

FIG. 1 is a plot depicting the effect of heat on permanent set of an example polymer (Example C after a pre-strain of 300%, extension of 66.75 mm). FIG. 1 represents the permanent set of Example C film that has been pre-stretched to 300% strain at 333%/minute. The permanent set (the initial permanent set) of Example C is initially about 30% after 10 minutes of allowing the sample to shrink free of constraint (free shrinkage). The samples are placed on Teflon™ sheets and inserted into a Blue M Electric Stabil-Therm convection oven pre-heated to a set temperature shown in the plot. The samples undergo rapid additional shrinkage which is essentially complete in less than one minute (typically less than 10 seconds) at the specified temperature. At about 40 to about 60° C., heat shrinkage is essentially complete and permanent set (the post-shrink permanent set) was about 0%. The curve can be described by a sigmoidal relationship. Though not intended to be limited by theory, it is thought that the effect originates from the gradual melting of crystals within the polymer. A sufficiently broad melting distribution is thought to facilitate this effect. As lower melting crystals are eliminated by heating, amorphous chains anchored in higher melting crystals are thought to retract, thereby resulting in shrinkage or decrease in permanent set.

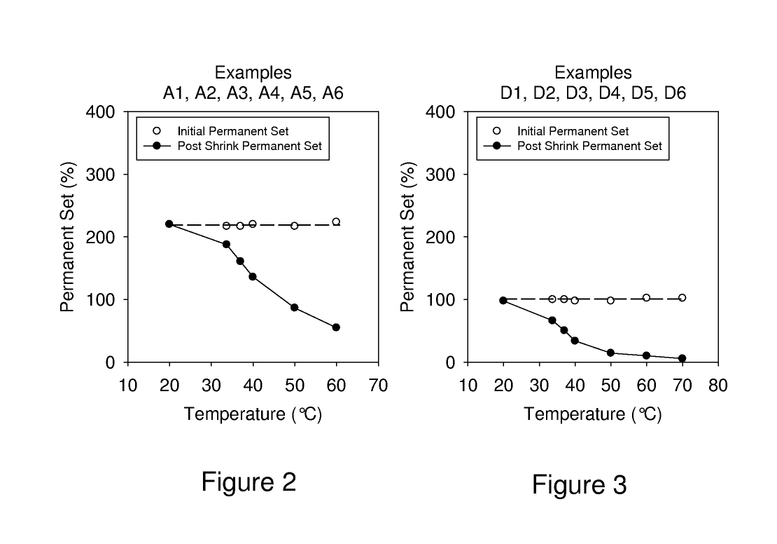

FIGS. 2 and 3 are plots depicting the effect of heat on permanent set of example polymers (Examples A and D after a pre-strain of 900%, respectively). Experiments similar to those performed for Example C of FIG. 1 were performed for Examples A and D pre-stretched to 900% strain. As shown in FIGS. 2 and 3, increased temperatures result in progressively higher shrinkage (or decreasing permanent set). In the absence of heat shrinkage, the samples did not decrease in permanent set. In this way, the utility of heat-shrinkage for elastomers has been demonstrated.

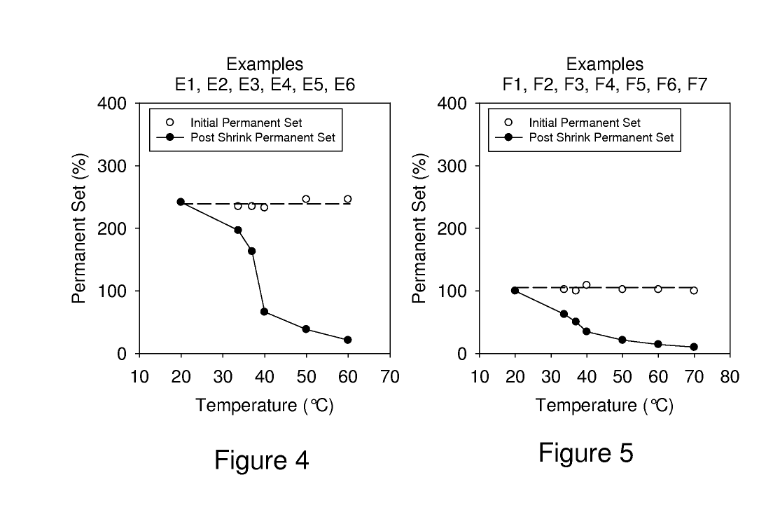

FIGS. 4 and 5 are plots depicting the effect of heat on permanent set of example polymers (Example E and F after a pre-strain of 900%, respectively) in accordance with an embodiment. Experiments similar to those performed for Example C of FIG. 1, were performed for Examples E and F pre-stretched to 900% strain. As shown in FIGS. 4 and 5, increased temperatures result in progressively higher shrinkage (or decreasing permanent set). In the absence of heat shrinkage, the samples did not decrease in permanent set. In this way, the utility of heat-shrinkage for propylene-based elastomers has been demonstrated.

The heat shrinkage results of a sample set of experiments are summarized in Table 4. The film is made from the resin corresponding to the first letter, such that A1 is the first film made using resin A of Table 1. Note that in Table 4 the ‘-c’ suffix denotes comparative examples (e.g., A1-c, C1-c, D1-c, E1-c, F1-c, G1-c). All others examples are embodiment examples.

TABLE 4
Heat Shrinkage Results (Example corresponds with
polymers in Table 1, Table 2 and Table 3).

| | | | | | Post- |
|---|---|---|---|---|---|
| | | Heat | | Initial | Shrink |
| | Pre- | Shrink | Initial | Perm. | Perm. |
| | Strain | Temp | Length | Set | Set |
| Example | (%) | (° C.) | (mm) | (%) | (%) |
| A1-c | 900 | 20 | — | 220.0 | 220.0 |
| A2 | 900 | 33.7 | 63.22 | 216.9 | 187.6 |
| A3 | 900 | 37 | 59.25 | 216.9 | 160.7 |
| A4 | 900 | 40 | 52.95 | 220.0 | 136.0 |
| A5 | 900 | 50 | 42.74 | 216.9 | 86.5 |
| A6 | 900 | 60 | 35.92 | 223.6 | 55.1 |
| C1-c | 300 | 20 | 28.9 | 6.7 | 30.0 |
| C2 | 300 | 37 | 28.9 | 6.7 | 24.0 |
| C3 | 300 | 50 | 28.9 | 6.7 | 0.0 |
| C4 | 300 | 60 | 28.9 | 6.7 | 1.6 |
| D1-c | 900 | 20 | 41.51 | 97.8 | 97.8 |
| D2 | 900 | 33.7 | 36.95 | 100.0 | 66.3 |
| D3 | 900 | 37 | 34.21 | 100.0 | 50.6 |
| D4 | 900 | 40 | 30.5 | 97.8 | 33.9 |
| D5 | 900 | 50 | 25.93 | 97.8 | 14.6 |
| D6 | 900 | 60 | 24.05 | 102.2 | 10.1 |
| D7 | 900 | 70 | 23.5 | 102.2 | 5.6 |
| E1-c | 900 | 20 | 76.77 | 241.6 | 241.6 |
| E2 | 900 | 33.7 | 68.13 | 234.8 | 196.6 |
| E3 | 900 | 37 | 31.79 | 234.8 | 162.9 |
| E4 | 900 | 40 | 53.28 | 232.6 | 66.3 |
| E5 | 900 | 50 | 40.08 | 246.1 | 38.4 |
| E6 | 900 | 60 | 33.22 | 246.1 | 21.3 |
| F1-c | 900 | 20 | 44.14 | 100.0 | 100.0 |
| F2 | 900 | 33.7 | 38 | 102.2 | 62.7 |
| F3 | 900 | 37 | 34.25 | 100.0 | 50.6 |
| F4 | 900 | 40 | 31.44 | 109.0 | 34.8 |
| F5 | 900 | 50 | 27.85 | 102.2 | 21.3 |
| F6 | 900 | 60 | 26.85 | 102.2 | 14.6 |
| F7 | 900 | 70 | 25.67 | 100.0 | 10.1 |
| G1-c | 900 | 20 | 22.25 | 14.6 | 14.6 |
| G2 | 900 | 33.7 | 24.7 | 16.9 | 13.3 |
| G3 | 900 | 37 | 25.03 | 14.6 | 13.3 |
| G4 | 900 | 40 | 24.6 | 13.3 | 12.4 |
| G5 | 900 | 50 | 24.1 | 14.6 | 10.1 |
| G6 | 900 | 60 | 24.06 | 14.6 | 5.6 |
| G7 | 900 | 70 | 24.71 | 14.6 | 5.6 |

Note:
‘-c’ suffix denotes are comparative examples (e.g., A1-c, C1-c, D1-c, E1-c, F1-c, G1-c). All others are embodiment examples.

What is claimed is:

1. An article comprising a low crystallinity polymer layer comprised of a low crystallinity polymer, where the article having an original length and original width is elongated at a temperature below the melting point of the low crystallinity polymer to an elongation of at least 50% in at least one direction of the article's original length or original width to form a pre-stretched article with an initial permanent set.

2. An article, comprising:
a. a low crystallinity polymer layer comprising a low crystallinity polymer, and
b. a high crystallinity polymer layer comprising a high crystallinity polymer where the high crystallinity polymer has a melting point as determined by Differential Scanning Calorimetry (DSC) within about 25° C. of the melting point of the low crystallinity polymer, and
where the article having an original length and original width is elongated at a temperature below the melting point of the low crystallinity polymer to an elongation of at least 50% in at least one direction of the article's original length or original width to form a pre-stretched article with an initial permanent set.

3. The article of claim 1 or 2, further comprising where the pre-stretched article is subsequently heat-shrunk at a temperature not greater than 10° C. above the melting point of the low crystallinity polymer to form a heat-shrunk article with a post-shrink permanent set, where the post-shrink permanent set is reduced by at least 25% as compared to the initial permanent set.

4. The article of claim 2, where the high crystallinity polymer has a melting point as determined by Differential Scanning Calorimetry (DSC) less than that of the melting point of the low crystallinity polymer.

5. The article of claim 1 or 2, where one or more comonomers is present in the low crystallinity polymer in an amount of from about 2 weight % to about 25 weight % of the total weight of the low crystallinity polymer layer.

6. The article of claim 1 or 2, where the low crystallinity polymer comprises thermoplastic elastomers, where the thermoplastic elastomers comprises at least one thermoplastic elastomer selected from the group comprising SEBS, SES, SIS, ethylene-based polymers, propylene-based polymers, and blends thereof.

7. The article of either claim 1 or claim 2, where the low crystallinity polymer layer comprises at least one layer selected from the group consisting of a film, a non-woven fabric layer, and a fibrous layer.

8. The article of either claim 1 or claim 2, where the low crystallinity polymer comprises an olefin block copolymer (OBC).

9. The article of claim 2, where the low crystallinity polymer layer comprises at least about 45% of the combined weight of the low and high crystallinity polymer layers.

10. The article of claim 2, where the high crystallinity polymer layer comprises less than about 20% of the combined weight of the low and high crystallinity polymers layers.

11. The article of claim 2, where at least one of the low crystallinity polymer layer and the high crystallinity polymer layer comprises at least one of a nonwoven layer, a woven fibrous layer, and a film layer.

12. The article of claim 2, where the low crystallinity polymer layer is in contact with the high crystallinity polymer layer.

13. The article of claim 2, where the article comprises a film further comprised of an additional layer in contact with the high crystallinity polymer layer.

14. The article of claim 1 or claim 2, where the article comprises a film further comprised of an additional layer in contact with the low crystallinity polymer layer.

15. The article of claim 2, where at least one of the low and high crystallinity polymers are plastically deformed.

16. The article of either claim 1 or claim 2, where the article is in the form of a fiber.

17. A web comprised of one or more fibers of claim 16.

18. The article of either claim 1 or claim 2, where the article comprises at least 3 layers and where a non-skin layer comprises the low crystallinity polymer.

19. The article of claim 2, where the article comprises at least 3 layers and where at least one skin layer comprises the high crystallinity polymer.
